(19) United States
(12) Patent Application Publication
(10) Pub. No.: US 2024/0257154 A1
(43) Pub. Date: Aug. 1, 2024

(54) LICENSED FEATURE COUNTER

(71) Applicant: Hewlett-Packard Development Company, LP., Spring, TX (US)

(72) Inventors: Paul L Jeran, Boise, ID (US); Jesse Otto Sutherland, Vancouver, WA (US)

(21) Appl. No.: 18/565,687

(22) PCT Filed: Jun. 1, 2021
(86) PCT No.: PCT/US2021/070647

§ 371 Date: Nov. 30, 2023

(51) Int. Cl. G06Q 30/018

(52) U.S. Cl. CPC G06Q 30/018

(57) ABSTRACT

Examples disclosed herein relate to modifying a counter associated with a licensed feature, modifying the counter upon an occurrence of an event, determining whether the counter has passed a threshold value, and, in response to determining that the counter has passed the threshold value, causing the licensed feature to become unlicensed.

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates).

### BRIEF DESCRIPTION OF THE DRAWINGS

FIG. 1 is a block diagram of an example computing device for providing a licensed feature counter.

FIG. 2 is a flowchart of an example method for providing a licensed feature counter.

FIG. 3 is a block diagram of an example system for providing a licensed feature counter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Most printers and multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

In some devices, certain features may be licensed based on various subscription or purchase plans. For example, a user may purchase a device with variable levels of print quality, from draft to photo. The user may also subscribe to a replenishment service, such as ink, toner, media, additive material, etc. that provides regular resupply of the subscribed item(s) and/or access to service(s). The replenishment service may be associated with certain features of the device, such as enabling photo quality printing so long as the user subscribes to a photo paper replenishment service, enabling faster print speeds so long as the user subscribes to a print supply replenishment service, and/or enabling access to a 3D print model library while the user is subscribed to a 3D printer additive material replenishment service.

The device may validate the user's continued enrollment and/or compliance with the replenishment service when the associated features are used. The enrollment may be associated with a counter associated with a number of times the feature may be used, such as a number of pages or amount of consumable supplies used. In some implementations, the counter may comprise a timer, such as a number of days the feature remains enabled. For example, the user may wish to print several pages at high speed, so the device may validate that the enrollment counter has sufficient pages remaining to ensure compliance with a replenishment service that provides high-speed certified toner material. In some implementations, access to the features this may be accomplished via a network connection to a subscription control service and/or installation of a firmware update, such as through a local disk and/or Universal Serial Bus (USB) connection. However, such a connection may not always be available.

In some implementations, therefore, the access to the features may be extended through updates provided when new consumable supplies are provided to the device. For example, an ink and/or toner cartridge may be authenticated as being associated with the replenishment service, and the counter may be modified by some amount when that cartridge is inserted. In some implementations, a cartridge identifier may be recorded so that the same cartridge cannot be used multiple times to modify the same counter.

In some implementations, the update to the counter may be associated with an update to a list of supply identifiers. Such a list may be associated with valid, invalid, and/or unknown status supplies. For example, the cartridge identifier for the cartridge used to modify the counter may be on the valid list when inserted, but moved to the invalid list once its identifier has exhausted an authorized number of times to modify the licensed feature counter. Modifying the counter may comprise, for example, incrementing the counter, decrementing the counter, resetting the counter, and/or setting a value for the counter, etc. Other supply identifiers may be known, for example, to be used in refilled supplies, and may be included on the invalid list. This list may be maintained by the device to validate against future supplies to determine whether those supplies are suitable for the device and/or the licensed feature. In some implementations, such invalid supplies may be used by the device, but may be restricted from use with the licensed feature.

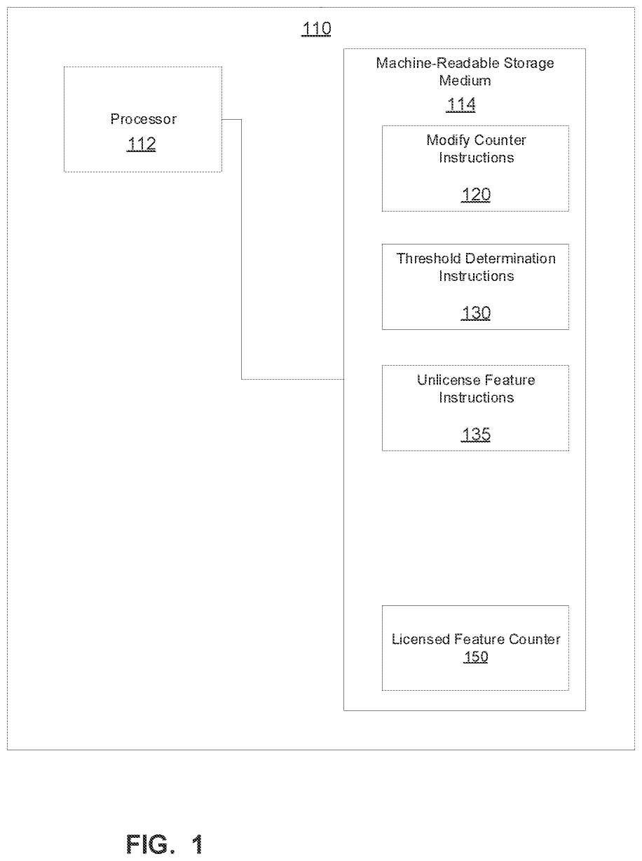

FIG. 1 is a block diagram of an example computing device 110 for providing a licensed feature counter. Computing device 110 may comprise a processor 112 and a non-transitory, machine-readable storage medium 114. Storage medium 114 may comprise a plurality of processor-executable instructions, such as modify counter instructions 120, threshold determination instructions 130, and unlicense feature instructions 135. In some implementations, instructions 120, 130, 135 may be associated with a single computing device 110 and/or may be communicatively coupled among different computing devices such as via a direct connection, bus, or network. Storage medium 114 may further comprise a licensed feature counter 150 comprising a stored value that may be modified, read, set, adjusted, incremented, decremented, etc. by instructions 120, 130, 135.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 130, 135.

Executable instructions 120, 130, 135 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random-access memory (SRAM), dynamic random-access memory (DRAM), and/or magnetic random-access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Modify counter instructions 120 may modify a counter associated with a licensed feature. Licensed features may comprise, for example, performance enhancement (e.g., print speed), document processing options (e.g., duplexing, color enhancement, photo printing, etc.), device operations (e.g., scanning, faxing, etc.), and/or other features that may be restricted for use. Such restrictions may, for example, be associated with a subsidized device cost and/or subscription membership. The counter, such as licensed feature counter 150, may be modified by modify counter instructions 120 to indicate that an associated licensed feature may continue to be used. For example, where licensed feature counter 150 comprises a timestamp, modify counter instructions 120 may add some period of time (e.g., 30 days) to the timestamp.

In some implementations, licensed feature counter 150 may be associated with a plurality of different licensed features, and/or different licensed features may be associated with different licensed feature counters. In some implementations, licensed feature counter 150 may comprise a numeric value, such as a number of times an associated licensed feature may be used (e.g., a number of pages scanned, a number of time optical character recognition can be used), a page count, and/or a timestamp, such as a time that access to the licensed feature may be revoked. In some implementations, licensed feature counter 150 may comprise a pair of opposed monotonic counters wherein one of the pair is modified to indicate availability of the licensed feature while the other is modified to indicate occurrence of an event associated with a use of the licensed feature.

In some implementations, modify counter instructions 120 may comprise instructions to validate an installed component. For example, a newly installed print material cartridge (e.g., an ink cartridge) may comprise an identifier. The cartridge identifier may be compared to a list, potentially stored in storage medium 114, of valid cartridge identifiers. Instructions 120 may validate the installed component if the identifier matches an identifier on the list of valid cartridge identifiers.

In some implementations, modify counter instructions 120 may comprise instructions to update a stored list of component identifiers from the validated installed component. For example, once validated, an updated list of valid component identifiers may be retrieved from the validated installed component. Such components may comprise an on-board memory for storing their own identifier and lists and/or links to updated lists of valid component identifiers. Such updates may add new valid identifiers and/or remove previously valid identifiers.

In some implementations, modify counter instructions 120 may comprise instructions to modify the counter by an amount associated with a size of the updated stored list of component identifiers. For example, licensed feature counter 150 may comprise a timestamp comprising a future date at which time access to an associated licensed feature will expire. When a new component is installed and validated, the list of valid component identifiers may be updated. If the new component comprises only a small update to the list of valid component identifiers, the extension to licensed feature counter 150 may be smaller than when the new component provides a large update to the list. For example, a small update that adds 200 identifiers and removes 100 identifiers from the valid identifier list may add 10 days to licensed feature counter 150 while a large update that adds 1000 identifiers and removes 1000 identifiers may add 30 days to licensed feature counter 150.

In some implementations, modify counter instructions 120 may comprise instructions to validate a timestamp of the installed component and disregard the instructions 120 to update the stored list of component identifiers if the timestamp is older than a threshold time period. For example, a newly installed component may comprise a manufacturing timestamp in addition to an identifier. If the manufacturing timestamp is earlier to or within a threshold range after a last time the list of valid component identifiers was updated, the newly added component's list of valid identifiers may be disregarded as out of date.

Modify counter instructions 120 may further modify the counter upon an occurrence of an event. For example, the event may comprise an expiration of a time period. In such examples, licensed feature counter 150 may comprise a number of days the device 110 has access to the licensed feature and the occurrence of the event may comprise the passage of a time period such as 1 day. The licensed feature counter 150 is thus modified 1 day for each day that passes. For another example, the event may comprise a use of a portion of a consumable component, such as a print material (e.g., paper, media, additive material, ink, toner, etc.). Such an event may comprise, for example, printing a page by device 110. Licensed feature counter 150 may comprise a number of pages allowed to be printed with access to the associated licensed feature and may thus be modified for each page that is printed.

Threshold determination instructions 130 may determine whether the counter has passed a threshold value. For example, where licensed feature counter 150 comprises a number of pages allowed to be printed, instructions 130 may determine when that number of pages has been reached by determining when licensed feature counter 150 has reached zero after being modified for each page printed. For another example, where licensed feature counter 150 comprises a date on which access to the associated licensed feature expires, instructions 130 may determine when that date is reached by comparing a timestamp in licensed feature counter 150 to a current date and/or by determining when a number of days remaining has reached zero.

Unlicense feature instructions 135 may cause the licensed feature to become unlicensed. For example, where the associated licensed feature comprises a performance enhancement (e.g., faster page printing), device 110 may be restricted from using that enhanced performance by instructions 135. Access to other features, such as scanning and/or faxing and/or enhanced print modes, may similarly be disabled by instructions 135.

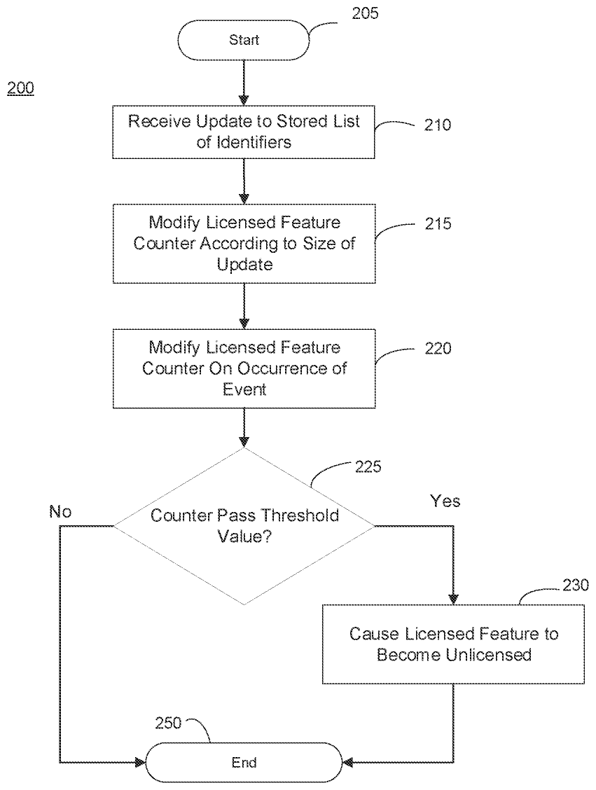

FIG. 2 is a flowchart of an example method 200 for a licensed feature counter. Although execution of method 200 is described below with reference to computing device 110, other suitable components for execution of method 200 may be used.

Method 200 may begin at stage 205 and advance to stage 210 where device 110 may receive an update to a stored list of identifiers associated with valid replaceable components. In some implementations, the update to the stored list of identifiers may be received from an external source, such as a network source provided by a manufacturer of device 110 and/or available replaceable components. In some implementations, the update to the stored list of identifiers may be received from a newly installed replaceable component, such as a print material cartridge. In some implementations, the newly installed replaceable component may comprise an identifier associated with one of the stored list of identifiers associated with valid replaceable components. In some implementations, the stored list of identifiers may be updated as part of an update to the firmware of device 110, such as may be downloaded via a network and/or installed via a memory device like a Universal Serial Bus (USB) memory device.

Method 200 may then advance to stage 215 where computing device 110 may modify a counter associated with a licensed feature according to a size of the update to the stored list of identifiers. For example, device 110 may execute modify counter instructions 120 to modify a counter associated with a licensed feature. Licensed features may comprise, for example, performance enhancement (e.g., print speed), document processing options (e.g., duplexing, color enhancement, photo printing, etc.), device operations (e.g., scanning, faxing, etc.), and/or other features that may be restricted for use. Such restrictions may, for example, be associated with a subsidized device cost and/or subscription membership. The counter, such as licensed feature counter 150, may be modified by modify counter instructions 120 to indicate that an associated licensed feature may continue to be used. For example, where licensed feature counter 150 comprises a timestamp, modify counter instructions 120 may add some period of time (e.g., 30 days) to the timestamp.

In some implementations, licensed feature counter 150 may be associated with a plurality of different licensed features, and/or different licensed features may be associated with different licensed feature counters. In some implementations, licensed feature counter 150 may comprise a numeric value, such as a number of times an associated licensed feature may be used, and/or a timestamp, such as a time that access to the licensed feature may be revoked.

In some implementations, modify counter instructions 120 may comprise instructions to validate an installed component. For example, a newly installed print material cartridge (e.g., an ink cartridge) may comprise an identifier. The cartridge identifier may be compared to a list, potentially stored in storage medium 114, of valid cartridge identifiers. Instructions 120 may validate the installed component if the identifier matches an identifier on the list of valid cartridge identifiers.

In some implementations, modify counter instructions 120 may comprise instructions to update a stored list of component identifiers from the validated installed component. For example, once validated, an updated list of valid component identifiers may be retrieved from the validated installed component. Such components may comprise an on-board memory for storing their own identifier and lists and/or links to updated lists of valid component identifiers. Such updates may add new valid identifiers and/or remove previously valid identifiers.

In some implementations, modify counter instructions 120 may comprise instructions to modify the counter by an amount associated with a size of the updated stored list of component identifiers. For example, licensed feature counter 150 may comprise a timestamp comprising a future date at which time access to an associated licensed feature will expire. When a new component is installed and validated, the list of valid component identifiers may be updated. If the new component comprises only a small update to the list of valid component identifiers, the extension to licensed feature counter 150 may be smaller than when the new component provides a large update to the list. For example, a small update that adds 200 identifiers and removes 100 identifiers from the valid identifier list may add 10 days to licensed feature counter 150 while a large update that adds 1000 identifiers and removes 1000 identifiers may add 30 days to licensed feature counter 150.

In some implementations, modify counter instructions 120 may comprise instructions to validate a timestamp of the installed component and disregard the instructions 120 to update the stored list of component identifiers if the timestamp is older than a threshold time period. For example, a newly installed component may comprise a manufacturing timestamp in addition to an identifier. If the manufacturing timestamp is earlier to or within a threshold range after a last time the list of valid component identifiers was updated, the newly added component's list of valid identifiers may be disregarded as out of date.

Method 200 may then advance to stage 220 where computing device 110 may modify the counter associated with the licensed feature upon an occurrence of an event. For example, device 110 may execute modify counter instructions 120 to increment and/or decrement the counter upon an occurrence of an event. For example, the event may comprise an expiration of a time period. In such examples, licensed feature counter 150 may comprise a number of days the device 110 has access to the licensed feature and the occurrence of the event may comprise the passage of a time period such as 1 day. The licensed feature counter 150 is thus modified 1 day for each day that passes. For another example, the event may comprise a use of a portion of a consumable component, such as a print material (e.g., paper, media, additive material, ink, toner, etc.) and/or a physical component such as a paper tray, roller, fuser, printhead, etc. Such an event may comprise, for example, printing a page by device 110. Licensed feature counter 150 may comprise a number of pages allowed to be printed with access to the associated licensed feature and may thus be modified for each page that is printed.

Method 200 may then advance to stage 225 where computing device 110 may determine whether the counter has passed a threshold value. For example, device 110 may execute threshold determination instructions 130 to determine whether the counter has passed a threshold value. For example, where licensed feature counter 150 comprises a number of pages allowed to be printed, instructions 130 may determine when that number of pages has been reached by determining when licensed feature counter 150 has reached zero after being modified for each page printed. For another example, where licensed feature counter 150 comprises a date on which\access to the associated licensed feature expires, instructions 130 may determine when that date is reached by comparing a timestamp in licensed feature counter 150 to a current date and/or by determining when a number of days remaining has reached zero. In some implementations, threshold determination instructions 130 may determine whether licensed feature counter 150 has sufficient value to complete a user's request. For example, where a user may attempt to print a 20-page document, but licensed feature counter 150 comprises only 10 pages remaining, licensed feature counter 150 may be determined to have passed the threshold value despite not being at zero.

When licensed feature counter 150 is determined to be below the threshold value at stage 225, method 200 may then advance to stage 230 where computing device 110 may, in response to determining that the counter has passed the threshold value, cause the licensed feature to become unlicensed. For example, device 110 may execute unlicense feature instructions 135 to cause the licensed feature to become unlicensed. For example, where the associated licensed feature comprises a performance enhancement (e.g., faster page printing), device 110 may be restricted from using that enhanced performance by instructions 135. Access to other features, such as scanning and/or faxing, may similarly be disabled by instructions 135.

Method 200 may then end at stage 250.

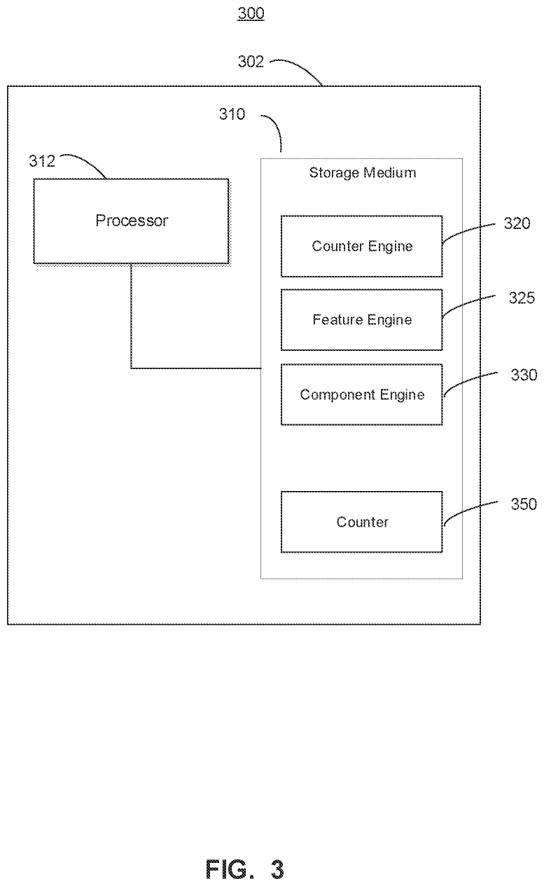

FIG. 3 is a block diagram of an example apparatus 300 for providing a licensed feature counter. Apparatus 300 may comprise a multi-function printer device 302 comprising a storage medium 310, and a processor 312. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, a counter engine 320, a feature engine 325, and a component engine 330.

Each of engines 320, 325, 330 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325, 330. In such examples, device 302 may comprise the machine-readable storage medium storing the instructions and the processing resource to execute the instructions, or the machine-readable storage medium may be separate but accessible to apparatus 300 and the processing resource.

In some implementations. counter engine 320 may increment a counter 350 associated with a licensed feature and modify the counter upon an occurrence of an event. In some implementations, counter 350 may be modified upon occurrence of the event and modified when additional uses of the feature are authorized. For example, counter engine 320 may execute modify counter instructions 120 to modify a counter associated with a licensed feature. Licensed features may comprise, for example, performance enhancement (e.g., print speed), document processing options (e.g., duplexing, color enhancement, photo printing, etc.), device operations (e.g., scanning, faxing, etc.), and/or other features that may be restricted for use. Such restrictions may, for example, be associated with a subsidized device cost and/or subscription membership. The counter 350, which may comprise licensed feature counter 150, may be modified by modify counter instructions 120 to indicate that an associated licensed feature may continue to be used. For example, where licensed feature counter 150 comprises a timestamp, modify counter instructions 120 may add some period of time (e.g., 30 days) to the timestamp.

In some implementations, licensed feature counter 150 may be associated with a plurality of different licensed features, and/or different licensed features may be associated with different licensed feature counters. In some implementations, licensed feature counter 150 may comprise a numeric value, such as a number of times an associated licensed feature may be used, and/or a timestamp, such as a time that access to the licensed feature may be revoked.

Counter engine 320 may modify the counter associated with the licensed feature upon an occurrence of an event. For example, device 310 may execute modify counter instructions 120 to modify the counter upon an occurrence of an event. For example, the event may comprise an expiration of a time period. In such examples, licensed feature counter 150 may comprise a number of days the device 310 has access to the licensed feature and the occurrence of the event may comprise the passage of a time period such as 1 day. The licensed feature counter 150 is thus modified 1 day for each day that passes. For another example, the event may comprise a use of a portion of a consumable component, such as a print material (e.g., paper, media, additive material, ink, toner, etc.). Such an event may comprise, for example, printing a page by device 310. Licensed feature counter 150 may comprise a number of pages allowed to be printed with access to the associated licensed feature and may thus be modified for each page that is printed.

Feature engine 325 may determine whether the counter has passed a threshold value and, in response to determining that the counter has passed the threshold value, cause the licensed feature to become unlicensed. For example, device 310 may execute threshold determination instructions 130 to determine whether the counter has passed a threshold value. For example, where licensed feature counter 150 comprises a number of pages allowed to be printed, instructions 130 may determine when that number of pages has been reached by determining when licensed feature counter 150 has reached zero after being modified for each page printed. For another example, where licensed feature counter 150 comprises a date on which access to the associated licensed feature expires, instructions 130 may determine when that date is reached by comparing a timestamp in licensed feature counter 150 to a current date and/or by determining when a number of days remaining has reached zero. In some implementations, threshold determination instructions 130 may determine whether licensed feature counter 150 has sufficient value to complete a user's request. For example, where a user may attempt to print a 20-page document, but licensed feature counter 150 comprises only 10 pages remaining, licensed feature counter 150 may be determined to have passed the threshold value despite not being at zero.

Component engine 330 may validate a newly installed component of the system, update a list of component identifiers associated with valid replaceable components for the system, and provide a modify value to the counter engine based on a size of the list of component identifiers. In some implementations, the newly installed component of the system may be validated by determining whether the list of component identifiers associated with valid replaceable components comprises an identifier associated with the newly installed component prior to the update to the list of component identifiers.

For example, component engine 330 may execute modify counter instructions 120 to validate an installed component. For example, a newly installed print material cartridge (e.g., an ink cartridge) may comprise an identifier. The cartridge identifier may be compared to a list, potentially stored in storage medium 114, of valid cartridge identifiers. Instructions 120 may validate the installed component if the identifier matches an identifier on the list of valid cartridge identifiers.

In some implementations, modify counter instructions 120 may comprise instructions to update a stored list of component identifiers from the validated installed component. For example, once validated, an updated list of valid component identifiers may be retrieved from the validated installed component. Such components may comprise an on-board memory for storing their own identifier and lists and/or links to updated lists of valid component identifiers. Such updates may add new valid identifiers and/or remove previously valid identifiers.

In some implementations, modify counter instructions 120 may comprise instructions to modify the counter by an amount associated with a size of the updated stored list of component identifiers. For example, licensed feature counter 150 may comprise a timestamp comprising a future date at which time access to an associated licensed feature will expire. When a new component is installed and validated, the list of valid component identifiers may be updated. If the new component comprises only a small update to the list of valid component identifiers, the extension to licensed feature counter 150 may be smaller than when the new component provides a large update to the list. For example, a small update that adds 200 identifiers and removes 100 identifiers from the valid identifier list may add 10 days to licensed feature counter 150 while a large update that adds 1000 identifiers and removes 1000 identifiers may add 30 days to licensed feature counter 150.

In some implementations, modify counter instructions 120 may comprise instructions to validate a timestamp of the installed component and disregard the instructions 120 to update the stored list of component identifiers if the timestamp is older than a threshold time period. For example, a newly installed component may comprise a manufacturing timestamp in addition to an identifier. If the manufacturing timestamp is earlier to or within a threshold range after a last time the list of valid component identifiers was updated, the newly added component's list of valid identifiers may be disregarded as out of date.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed:

1. A non-transitory machine-readable medium storing instructions executable by a processor to:
modify a counter associated with a licensed feature;
modify the counter upon an occurrence of an event;
determine whether the counter has passed a threshold value; and
in response to determining that the counter has passed the threshold value, cause the licensed feature to become unlicensed.

2. The non-transitory machine-readable medium of claim 1, wherein the instructions to increment the counter comprise instructions to validate an installed component.

3. The non-transitory machine-readable medium of claim 2, wherein the instructions to validate an installed component further comprise instructions to update a stored list of component identifiers from the validated installed component.

4. The non-transitory machine-readable medium of claim 3, wherein the instructions to update the stored list of component identifiers from the validated installed component further comprise instructions to increment the counter by an amount associated with a size of the updated stored list of component identifiers.

5. The non-transitory machine-readable medium of claim 3, wherein the instructions to validate an installed component further comprise instructions to:
validate a timestamp of the installed component; and
disregard the instructions to update the stored list of component identifiers if the timestamp is older than a threshold time period.

6. The non-transitory machine-readable medium of claim 1, wherein the occurrence of the event comprises an expiration of a time period.

7. The non-transitory machine-readable medium of claim 1, wherein the occurrence of the event comprises a use of a portion of a consumable component.

8. The non-transitory machine-readable medium of claim 7, where the consumable component comprises a print material.

9. The non-transitory machine-readable medium of claim 8, wherein the use of the portion of the consumable component comprises printing a page using the print material.

10. A method comprising:
receiving an update to a stored list of identifiers associated with valid replaceable components;
modifying a counter associated with a licensed feature according to a size of the update to the stored list of identifiers;
modifying the counter associated with the licensed feature upon an occurrence of an event;
determining whether the counter has passed a threshold value; and
in response to determining that the counter has passed the threshold value, causing the licensed feature to become unlicensed.

11. The method of claim 10, wherein the update to the stored list of identifiers is received from an external source.

12. The method of claim 10, wherein the update to the stored list of identifiers is received from a newly installed replaceable component.

13. The method of claim 12, wherein the newly installed replaceable component is associated with one of the stored list of identifiers associated with valid replaceable components.

14. A system, comprising:
a counter engine to:
modify a counter associated with a licensed feature, and
modify the counter upon an occurrence of an event;
a feature engine to:
determine whether the counter has passed a threshold value,
in response to determining that the counter has passed the threshold value, cause the licensed feature to become unlicensed; and
a component engine to:
validate a newly installed component of the system,
update a list of component identifiers associated with valid replaceable components for the system, and
provide an increment value to the counter engine based on a size of the list of component identifiers.

15. The system of claim 14, wherein the newly installed component of the system is validated by determining whether the list of component identifiers associated with valid replaceable components comprises an identifier associated with the newly installed component prior to the update to the list of component identifiers.
